(19) United States
(12) Patent Application Publication
(10) Pub. No.: US 2015/0067028 A1
(43) Pub. Date: Mar. 5, 2015

(54) MESSAGE DRIVEN METHOD AND SYSTEM FOR OPTIMAL MANAGEMENT OF DYNAMIC PRODUCTION WORKFLOWS IN A DISTRIBUTED ENVIRONMENT

(71) Applicant: INDIAN SPACE RESEARCH ORGANISATION, Bangalore (IN)

(72) Inventors: M. Naresh KUMAR, Andhra Pradesh (IN); Uzair MUJEEB, Andhra Pradesh (IN); Ashwini JOSHI, Andhra Pradesh (IN); M. Vidya, Andhra Pradesh (IN); Raji JOSE, Andhra Pradesh (IN); P. Samatha, Andhra Pradesh (IN); T. Sailaja, Andhra Pradesh (IN); Sonu TOMAR, Andhra Pradesh (IN)

(73) Assignee: INDIAN SPACE RESEARCH ORGANISATION, Bangalore (IN)

(21) Appl. No.: 14/015,693

(22) Filed: Aug. 30, 2013

(51) Int. Cl. H04L 29/08

(52) U.S. Cl. CPC H04L 67/10
USPC 709/203

(57) ABSTRACT

Methods and system to control the data processing workflows in distributed environment with asynchronous message driven mechanism. A production workflow includes an ordered sequence of tasks to be executed that needs to be distributed on multiple computational nodes. Each task is assigned by a sender application to a receiver application running on a computational node through a message. On receiving the message, the receiver application sends and sends an acknowledgment to the message and schedules the sub tasks associated with the task. The sender application on receiving the acknowledgment removes the message from the queue otherwise the messages are stored in the database. On completion of the sub tasks the receiver application generates a message and the sender application on receipt of the message takes up the next task in the sequence and generates a message to another application. The sender application keeps on generating messages till all the tasks are completed in the sequence. The methods adopted in this invention provides persistence and guaranteed delivery of messages thereby improving the quality of service in transaction processing systems that are managing complex workflows.

### FIELD OF TECHNOLOGY

The present disclosure relates to systems, apparatuses and methods for data processing systems to collaborate and accomplish dynamic workflows in a distributed environment.

More particularly the present disclosure relates to techniques for managing dynamic production workflows through a persistence based message driven asynchronous communication between applications in a distributed environment. In addition, the workflows may be orchestrated in such a manner that the processing applications accomplish the tasks in a timely manner through efficient utilization of resources.

### BACKGROUND

In general, production workflows in computer-based applications such as data processing, supply chain management, data publishing systems, etc. comprise a set of jobs to be executed among computational nodes or to deliver information on multiple client systems. Each job may in turn require one or more tasks to be executed on the computational nodes. The workflow typically starts with the receipt of a task or a job from a sender application to a receiver application. The receiver application acknowledges the receipt of the task and after completion of the job communicates the exit status to the sender application. If the exit status indicates a success, the sending application schedules one of the subtasks to another receiver application running on a different computational node. The final deliverables are generated once all the tasks in the workflow are completed as per the desired order. In case the exit status indicates an error, an alarm is raised, and another task is taken up for processing. In a typical production scenario a predetermined number of requests in the pipeline need to be completed within a stipulated timeline. In the above scenarios, a workflow manager application manages the tasks by selecting appropriate processing application based on the parameters in the user request.

A workflow manager implemented through a client server architecture often possess limitations, such as tight coupling among software components. In addition, such a configuration may lead to inefficient utilization of resources as client applications need to wait for the server process to provide the data.

The implementation of product generation workflows using asynchronous communication, with non-persistent messaging, would pose serious problems due to a receiver application, running over a node connected to the sender application through the network, may go on or off in random order. This in turn would affect the delivery of the messages, and may lead to failures. If an exit status is not available, the workflow cannot proceed further, leading to non-fulfillment of the user request. Also, the computational resources in the distributed environment may not be fully exploited just by employing message based asynchronous methods of communication between workflow manager and the processing application. If large number of products are in the pipeline, this would result in an exponential increase in the number of workflows pending for completed. Further, this would lead to unpredictable product delivery timelines if appropriate steps were not taken in managing the workflows. Moreover, this may lead to suboptimal utilization of resources, as some of the products may never get a chance to execute, and would lead to unacceptable long delays in providing deliverables to users.

### BRIEF SUMMARY

In accordance with certain embodiments disclosed herein, methods and systems are disclosed for optimizing processing and management of dynamic production workflows utilizing asynchronous persistent message driven communication between the processing applications and the workflow manager.

To further optimize the workflows, certain embodiments incorporate methods that would ensure quality of service (QOS) from the processing systems in terms of improved turnaround time (TAT) and optimizing the throughput from the systems. In other embodiment, techniques are disclosed for managing and monitoring the dynamic production workflows.

In certain exemplary embodiments, techniques are disclosed for managing dynamic production workflows in distributed scheduling and transaction processing in a computer-based system. Distributed computational node processing and routing of the tasks by the workflow manager may be integrated using a persistent message queuing system to provide asynchronous communication between the applications.

In product generation workflows, a first application may send a communication to a second application for processing the requests pertaining to the users. The second application inserts the request into a database leading to a tuple level change that triggers a stored procedure, to generate a message. The message may be appended to the in-queue of the message queue (MQ) pertaining to the third application. A third application acknowledges the receipt of the messages and prepares the workflows for each of these products. If an acknowledgment is not received from the receiving application, then the message is again retried for a specific number of attempts. Based on the tasks in the workflow the third application looks into the local resource manager and generates a message that is appended into the MQ of a fourth application. The fourth application, which may reside on a node, sends an acknowledgment of the message and schedules a list of subtasks to be performed on the node. The workflow preferably comes to a halt only when the exit status of any of the application is either false, or all the tasks are completed without an exit status being false. The product in the pipeline is assumed to be successfully completed if all the tasks in the workflow are completed and they are ready to be delivered to the user.

In addition, message queues may be managed such that the priority is periodically updated automatically by an auto prioritize application so that all the workflows receive the required computational resources and are completed as per specified timelines.

On availability of one or more computational nodes, a load balancer application may automatically scale the performance of the workflow system by optimizing the distributing of load among the nodes based on weights obtained from the parameters such as resources on the node, resource requirement of the tasks and the type of processing required for generation of the product.

A dispatch engine may receive a message from an application after it completes the required processing on a computation node. On receipt of the message, the dispatch engine consults a knowledge base for generating a message to the next application based on the rules set for the job.

A reporting engine, issue tracker and an analytical engine may complement the workflow by providing means for monitoring, tracking and assessing the production environment.

An auto prioritize engine may build a model from the past data on the production environment to prioritize the requests currently pending in the workflow. The engine may first identify products waiting for allocation of resources, and subsequently build a model based on the parameters such as time spent in the workflow, probable time of completion etc., to prioritize the queues so that the delivery timelines meet the user requirement.

### BRIEF DESCRIPTION OF THE DRAWINGS

The present invention is illustrated by way of example and not limitation in the figures of the accompanying drawings, in which like references indicate similar elements and in which:

FIG. 1 is an exemplary system configuration for implementing the invention;

FIG. 2 is an exemplary architectural diagram of a message driven dynamic production workflows in a distributed environment;

FIG. 3 is a block diagram showing the perspective view of a system that is built to manage the production workflows in a remote sensing data processing environment under one exemplary embodiment;

FIG. 4 is an exemplary flow chart depicting a dispatcher engine that accepts the messages and after consulting the rule base generates messages for other applications;

FIG. 5 is an exemplary flow chart illustrating a global optimization procedure adopted for incrementing the priority of the messages by the auto prioritize engine;

FIG. 6 is an exemplary flow chart illustrating a local optimization procedure involved in increasing the priority of the messages by the auto prioritize engine;

FIG. 7 is an exemplary flow chart depicting the rescheduling of jobs by the load balancer in the event of fault in any of the nodes;

FIG. 8 is a block diagram showing the functioning of load balancing under another exemplary embodiment; and

FIG. 9 is an exemplary flow chart of the events depicting the distribution of jobs by the load balancer among computational nodes.

### DETAILED DESCRIPTION

The following discussion is aimed at disclosing architectural elements and providing a concise general description of the computing infrastructure in which the various embodiments may be implemented.

Real world problems are generally solved by divide and conquer strategies, i.e., each problem independently can be divided into sub problems and subsequently into tasks that can be executed on any computing infrastructure. The more experienced and skilled in the present art will appreciate the fact that the embodiments disclosed herein can be practiced not only on networked personal computers but also on multiprocessor/multi core machines, mainframe computers, hand held devices and the like. One may can even practice the invention in a distributed processing environment where in the real processing is done by applications running on a system connected through a network. The data and the programs required for processing may be located on the local computer or on the remote system. In a data centric approach, the processing applications may access the data from a centralized storage infrastructure such as storage area network and utilize the remote computing infrastructure to accomplish a task.

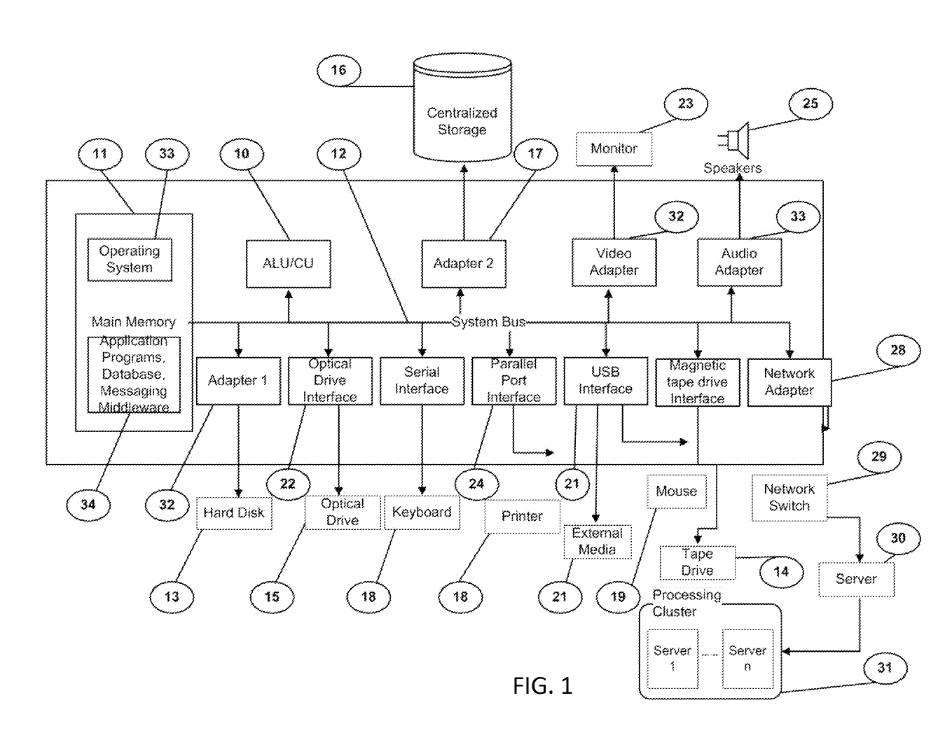

With reference to FIG. 1, an exemplary system comprises a computing infrastructure consisting of a general purpose computer with a multiprocessor/multi core unit (10), a system memory unit (11), a bus infrastructure (12) communicatively coupled to the processor, memory and other peripheral devices. System memory may comprise of a read only memory containing the basic input output system routines that are required to initialize the computer during the boot up process. The computer may further include a hard disk drive (13), magnetic devices (14) and optical devices (15) connected to the system bus through an adapter1 (32), tape drive interface (36), optical drive interface (22) respectively. Further, the system may be coupled to a centralized storage (16) through adapter2 (17) for accessing large data volumes of data by application running on remote compute nodes. Operating system kernel (33) and the application software modules (34) may reside in the read and write memory as long as the power is switched on. A database and the messaging middle ware may reside in the main memory of the exemplary system.

Users can access the system through input devices such as keyboard (18), and mouse (19). In general these input devices are connected to the processing unit through a serial port interface (38) via the system bus, but in addition they may also be connected through a universal serial bus (USB) (21) or optical interfaces (22). An external hard disk (37) may be connected through an interface to the system bus. Output devices such as video monitors (23) may be connected to the system bus through video adapters (35) via the system bus. In addition, the multimedia kit such as speaker (25) and microphone (26) are connected to the system through an adapter (36) to the processing unit via the system bus. A printer (18) may be configured through a parallel port interface (24) for taking hard copy outputs from the system.

The system may interact with other remote computers over a network environment through a network switch (29) via a network interface adapter (28) for connecting to the systems on the network. The communication between the processing nodes (30) may be implemented through network protocols. Applications residing on the processing nodes may in turn utilize a group of systems (31) for executing the tasks. It should be appreciated that the system shown in the FIG. 1 is exemplary and other forms of connectivity are possible among the systems.

In one exemplary embodiment, a workflow management system is disclosed in a network environment comprising message driven communication through queuing mechanism for receiving and transmitting the messages both from/to different applications. Messages may be generated by sensing a tuple level change in the database and transmitting the required information to the applications. A message may contain information specific to the application and is preferably added to a preconfigured message queue. Each message payload may contain data in the form of an object (business object) or it may include only control information for pointing to the data stored in the centralized repository. A typical application may comprise a software agent for sending and receiving messages and an interface module to invoke the processing modules required to accomplish the tasks by accessing data from centralized storage. The messages are made persistent by storing them in a database or in a file until a confirmation is received from respective applications.

Archiving the messages in a persistent storage before transmission in asynchronous mode ensures the delivery of the message payload even if the application is not in service at a certain point of time. The sending and receiving application may be on the same machine or on different machines connected by a network. Although a point to point communication is shown, those skilled in the art would appreciate that messages published by the workflow manager can be sent to all those applications who have subscribed to certain specific messages. Also, those skilled in the art should appreciate that messages can be delivered through a secured channel over a network. Further, one can extend the present embodiment to distribute the jobs to a remote workflow manager by routing the messages through a server. The remote workflow manager may in turn schedule jobs to applications on a different network of computer systems. The rerouting of jobs may be accomplished by incorporating appropriate processing rules to harness the distributed computational resources.

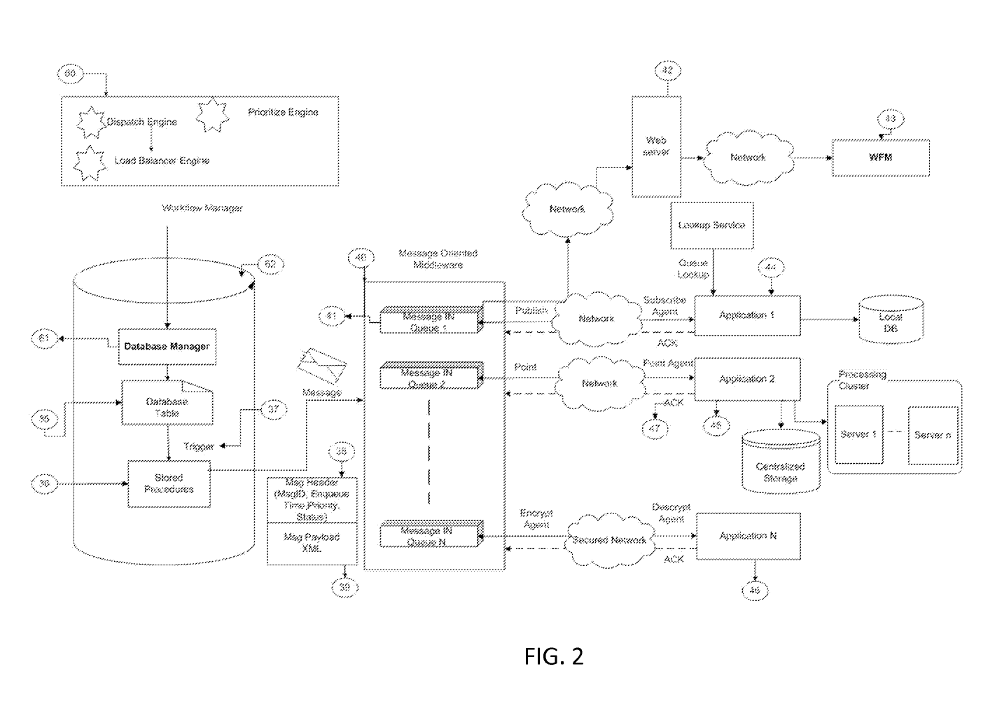

FIG. 2 illustrates an exemplary environment for running a message driven workflow management application. In accordance with one embodiment, complex workflows may be synthesized and executed in an optimal manner by integrating different components of workflows through asynchronous message delivery as a communication mechanism between the processing applications. Workflow manager (60) may comprise a dispatcher (111), load balancer (104), and auto prioritize engine (113). The workflow manager may initiate a change in the database tuple (35) through a database manager (61) on receipt of an external message (62) in the form of a user request. A trigger (37) may be generated on change of the database tuple further initiating a stored procedure (36) that creates a message (63) on a messaging middleware (40) and appends it to the persistent queue (41) of the respective application that is supposed to receive the message as per the rules stored in the knowledge base (KB) (103).

Each message preferably contains an identification number, time, status, priority (38) and/or a payload (39). An instance of the business object may be appended to the message by the workflow manager for delivering to the applications. In addition one can append even an extensible markup language (XML) file as message payload. The message is received by a software agent (65) which in turn invokes the processing modules of the application. The software agent is implemented as a daemon process. As soon as the message is en-queued, the agent listening to the queue would receive the message if the application (45) is configured in point to point mode. If the agent is not available at the time of receiving the message, the status would be retained as undelivered. When the agent comes online, it checks the availability of the messages through a queue look up service (64). The agent acknowledges (47) receipt of the messages and the status in the middleware is updated as received. If an acknowledgment is received from the agent for the message, the status is updated as delivered on the contrary if an acknowledgement is not received from the agent, the same message would be sent again (retransmitted) after a certain time gap. If the number of retries exceeds a predetermined value, the messages are assigned to an exception queue (65). The messages in the exception queue are automatically shown on to a issue tracker (114) user interface. Messages is recovered from the exception queue to the main queue once the error is resolved and updated using issue tracker (114) interface. Under another embodiment, only the location of the data is sent to the applications (45) along with the message wherein on its receipt it may initiate processing of jobs utilizing a group of (31) compute nodes by accessing the data from a centralized (16) storage. Some of the applications (44) may even store the message payload in a local database for subsequent processing or onward transmission.

One can even deliver the same message to multiple recipient applications (44) in a subscription mode under one embodiment. Also, the messages can be delivered in secured mode of transmission by incorporating required agents using services such as SSL and HTTPS for communication between the applications (46).

In case a database table is accessed by the processing application, the end application acknowledges the receipt of the message by updating the status of the tuple in the table. The processing applications, after completing the job, would insert a message into the queue through an agent or updating the status in the database.

The dispatcher engine of the workflow manager on receipt of the messages applies the business rules to route the request to other applications. User requests may be routed to the applications until all the required processing is completed.

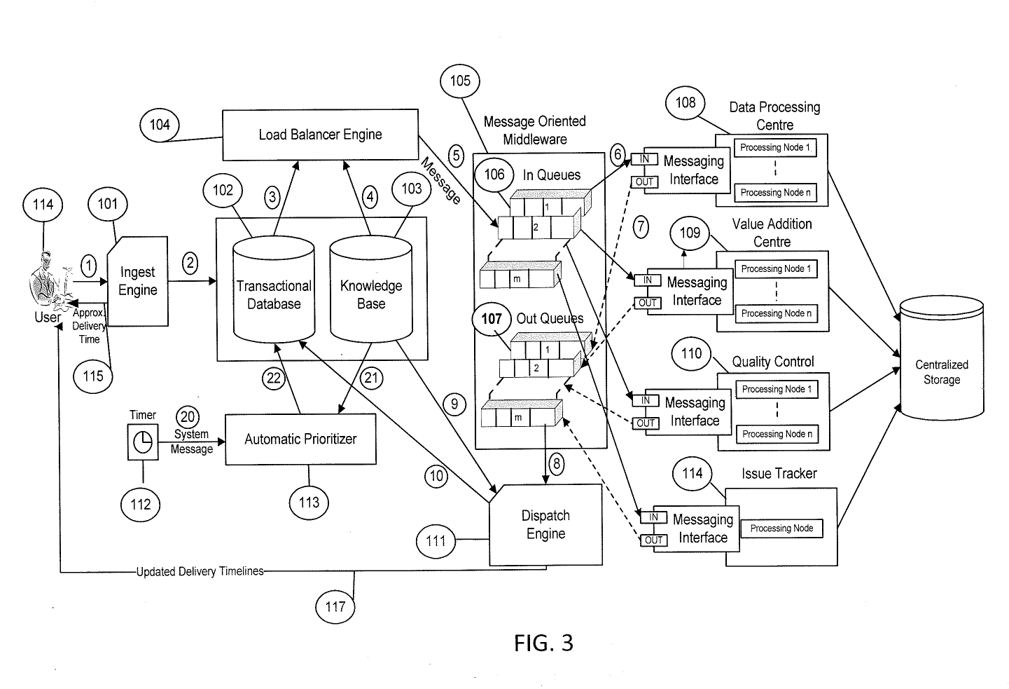

We now focus on FIG. 3 wherein a typical example of workflows in remote sensing data product generation is depicted under one embodiment. Here, the end product is a function of different processing functions done by software modules distributed across many computing resources. The workflow manager coordinates and automates these tasks through message driven interfaces. The users (114) raise a request for remote sensing data through an interface. The user is kept aware of the approximate delivery timelines (115) for completion of the request based on the computations taking into account the current load and performance of the computing infrastructure. On receipt of the request, an ingest engine (101) looks into the order details and updates in the transaction database (102). As soon as the tuple is inserted a stored procedure (36) inserts a message into a queue hosted inside a message oriented middleware (40) which is de-queued by the load balancer (104) and distributes the jobs among the computing nodes by inserting into the In queue (106) of the processing application after due consultation with a knowledge base (KB) (103). A typical workflow may comprise of data processing (108), value addition (109), and quality checking (110). Each of the processing applications after completing the assigned task inserts a message in the out queue (107). The dispatcher engine (111) de-queues the messages received after the update from the processing applications and delivers it to the subsequent application by updating the transaction database (102) based on its interpretation of the rules in the KB (103). An exemplary XML of the KB that is used for routing the messages is as follows:

```
  <?xml version=“1.0” encoding=“utf-8”?>
<xs:schema attributeFormDefault=“unqualified” elementFormDefault=
  “qualified” xmlns:xs=“http://www.w3.org/2001/XMLSchema”>
  <xs:element name=“route”>
<xs:complexType> <xs:sequence> <xs:element maxOccurs=
“unbounded” name=“rule”>
      <xs:complexType> <xs:attribute name=“routetag” type=
        “xs:string” use=“required” /> <xs:attribute name=
        “sourceapp” type=“xs:string”
        use=“required” /> <xs:attribute name=“destnapp” type=
        “xs:string”
        use=“required” /> <xs:attribute name=“sequence” type=
        “xs:unsignedshort”
        use=“required” />
  </xs:complexType> </xs:element> </xs:sequence> </xs:complexType>
  </xs:element>
</xs:schema>
```

The throughputs of different applications are measured and the timelines of delivery of products are updated in the KB. The products which require attention are monitored and resolved through an issue tracker (117). The updated timelines (118) are propagated back to the user to keep him abreast of the current situation.

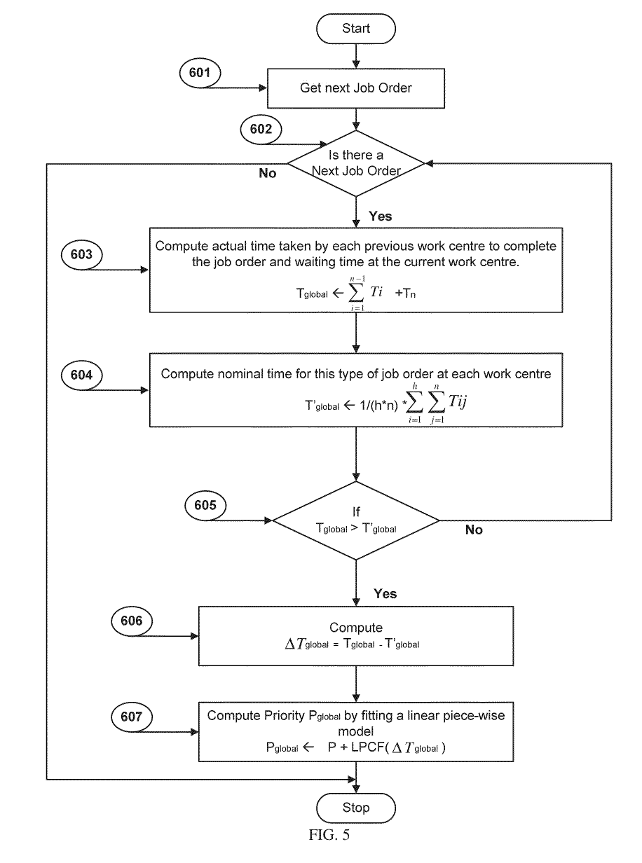

Turning now to FIG. 5, a global optimization procedure is depicted wherein the user jobs are prioritized based on the nominal timelines spent by similar type of jobs in the workflow.

For k^{th} job denoted by (Jₖ) in the workflow waiting for an assignment to a processing application a method to check whether the Job is running as per schedule. If a deviation is found a preventive measure is to prioritize the Job. Let T_{global} represent the total time spent by the Jₖ in the workflow, Tᵢ be the time taken by the i^{th} application to complete the sub task of the Job and Tₙ is the waiting time of the Jₖ at the n^{th} processing application. We compute (603) the total time spent by Jₖ as

$${T}_{global} ( {J}_{k} ) = {\sum }_{i = 1}^{n - 1} {T}_{i} ( {J}_{k} ) + {T}_{n} ( {J}_{k} ) . \qquad ( 1 )$$

In Step 604, a method for computing the nominal timelines of generation pertaining to jobs already processed in the workflow is presented. Let T_{global} represent the nominal time line, h is the total number of instances of a similar job order in the history, n is the total number of processing applications required for the k^{th} Job Jₖ and T_{pq} is the time taken by the p^{th} instance of a similar job order at q^{th} application is computed as an average of sum of the time taken by similar job orders by different application in the previous time steps. The T_{global}′ for k^{th} Job Jₖ is computed as

$${T}_{global}^{′} ( {J}_{k} ) = \frac{1}{( h * n )} * {\sum }_{p = 1}^{h} {\sum }_{q = 1}^{n} {T}_{pq} ( {J}_{k} ) \qquad ( 2 )$$

A simple comparison in Step 605 of T_{global} and T_{global}′ leads to Step 606. Let ΔT_{global} denote difference in timelines between the present Job and the nominal time taken for delivery of similar Job. One can compute ΔT_{global} as

ΔT_{global}(Jₖ)=T_{global}(Jₖ)−T_{global}′(Jₖ). (3)

The quantity ΔT_{global}>0 is an indication that the user request is being delayed and a preventive action needs to be initiated. Accordingly, an aspect current invention the new priority of the job order Jₖ is recomputed in Step 606 as

P_{global}(Jₖ)=P(Jₖ)+LPCF(P(Jₖ),ΔT_{global}(Jₖ)) (4)

where P_{global}(Jₖ) and P are the updated global priority and initial priority of the job order respectively. The LPCF in Equation 4 represents a linear piecewise polynomial function. Those skilled in the art would appreciate that other forms of curve fitting methods such as spline, rational polynomial function etc., may be adopted to fine tune the relationship between P and ΔT.

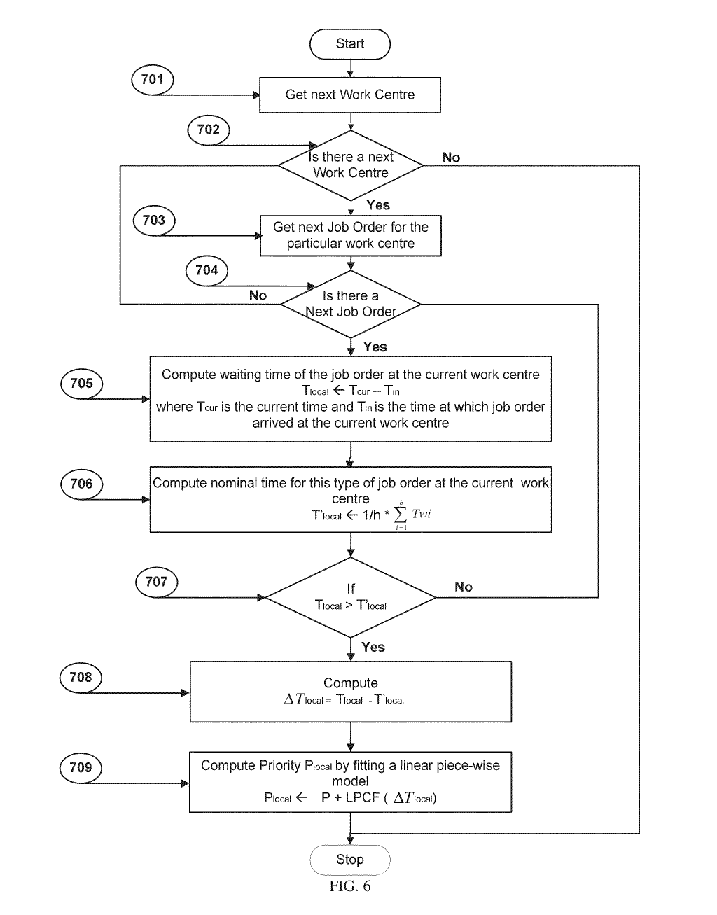

In FIG. 6 a procedure for modelling the local variations in job completion pertaining to a particular application is presented. Let Aᵣ denote a processing application corresponding to pending Job Jₖ. The Step 703 needs to be completed as a part of workflow W. The waiting time T_{local}(Aᵣ) of the job order for the application Aᵣ is computed in Step 705 as the difference between the current time T_{cur}(Aᵣ,Jₖ) and the time at which the job order Jₖ was received at the processing queue Aᵣ

T_{local}(Aᵣ,Jₖ)=T_{cur}(Aᵣ,Jₖ)−Tᵢₙ(Aᵣ,Jₖ). (5)

In Step 706, the nominal time of generation T_{local}′ for similar type of job order (Jₖ) in the application queue of Aᵣ is computed from workflow history as an average time taken by similar job jₖ by the processing application Aᵣ

$${T}_{local}^{′} ( {A}_{r} , {J}_{k} ) = \frac{1}{h} * {\sum }_{i = 1}^{h} {T}_{i} ( {A}_{r} , {J}_{k} ) , \qquad ( 6 )$$

where h is the total number of instances of similar job order processed earlier by the application Aᵣ and Tᵢ(Aᵣ,Jₖ) is the time taken by the i^{th} instance of a similar job order Jₖ by the processing application Aᵣ

A comparison of T_{local}(Aᵣ,Jₖ) and T_{local}′(Aᵣ,Jₖ)′ is shown in Step 707. The difference in between T_{local}(Aᵣ,Jₖ) and T_{local}′(Aᵣ,Jₖ) represented as ΔT_{local} is a measure of local variations in completing the Job of type Jₖ by the application Aᵣ computed in Step 708 as

ΔT_{local}(Aᵣ,Jₖ)=T_{local}(Aᵣ,Jₖ)−T_{local}′(Aᵣ,Jₖ). (7)

Based on the ΔT_{local}(Aᵣ,Jₖ) one can prioritize the user request Step 709 as

P_{local}(Aᵣ,Jₖ)=P(Jₖ))+LPCF(P(Jₖ),ΔT_{local}(Aᵣ,Jₖ)), (8)

where P_{local} and P are the updated local priority and initial priority of the job order respectively. The function LPCF represents a linear piecewise model.

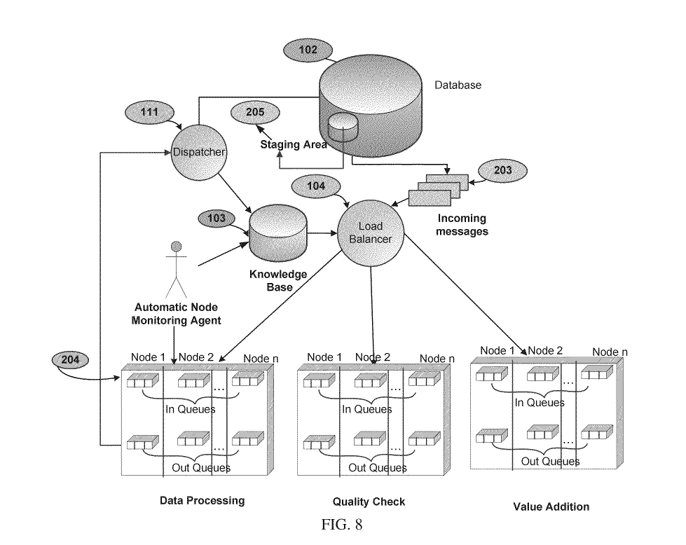

Turning to FIG. 8, a load balancer (104) performs the task of optimizing the distribution of jobs among various processing nodes of same processing application. It distributes in such a way that every job is assigned to that node where it has the best chances of getting processed earlier considering various parameters such as maximum size of the queue, current processing load, number of scheduled and unscheduled job and the job type. The parameters are stored in the KB (103) and retrieved by the load balancer while assigning the jobs to processing applications (204).

A transaction in a database (102) may act as a trigger for invocation of load balancer. A trigger initiates a message as soon as the transaction database is updated and the stored procedure adds the messages to the message queue of the load balancer application. On completion of the job the application updates the status as (success/failure) in the database leading to a message generation for the Job Dispatcher (111). The dispatcher consults the KB for updating the job to the next application. If an incoming job is of higher priority, then a need may arise for the load balancer to preempt some of the existing jobs (which are not under process) if the queue is already full. In case of node failure, the automatic node monitoring software generates a message to update the status of the node in the KB. An update of the tuple in the KB a message is generated for the load balancer. On receipt of the message, the load balancer fetches back all the jobs pending at that processing node and redistributes it among other available compute nodes. If the node again becomes available, it redistributes the work orders to attain equilibrium of load.

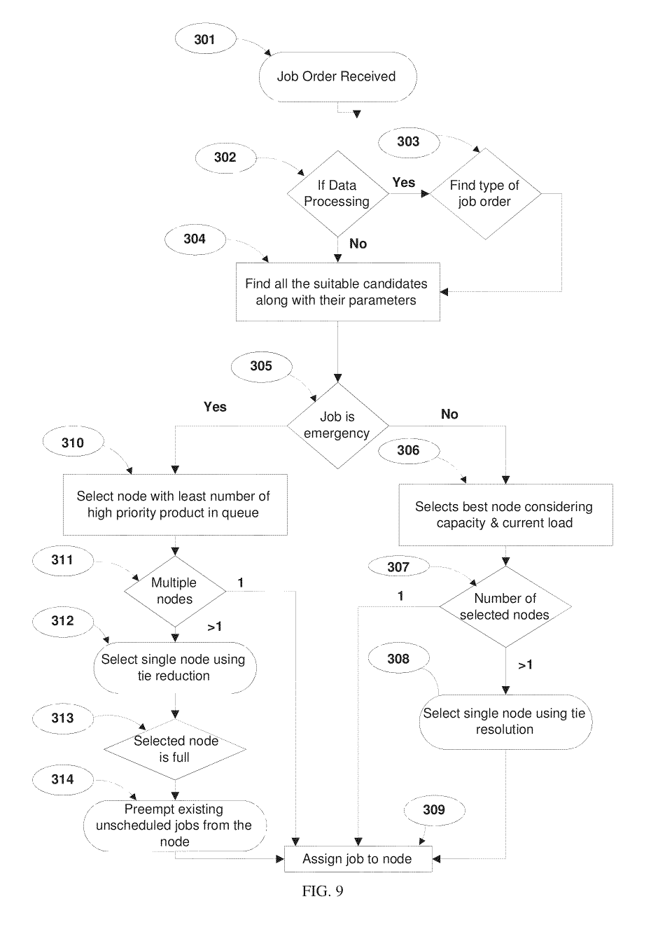

The jobs are in general comprise of both normal and emergency types. Referring to FIG. 9, a load distribution flowchart, on receipt of the job order (301), Load balancer checks the processing application of job (302). Those skilled in the art would appreciate that certain applications may have a further categorization of application sub types. In a typical case of remote sensing product generation, the application sub types are data processing (302) would of the type optical, microwave or non-imaging. For these cases the load balancer checks the subtypes and based on processing application and subtype (if present), it finds all the suitable computing nodes along with the parameters in KB for taking a decision (304). Further, it finds out whether the job is a high priority job or normal job (305). In case of normal job, the load balancer finds the best candidate by considering capacity and current load of each of the nodes (306). If a single such node is found (307), it assigns the job to that node (309) else, it performs a time resolution using the other parameters. For a high priority job, it finds the best possible node which has less number of high priority products (310) since those are the only ones in competition with this job. If more than one such node is available (311), it performs time resolution using other parameters such as delivery timelines committed to the user. If the selected node is already full (313), then instead of making the job wait, it preempts unscheduled jobs from that node (314) and puts them back into the staging area (205) and assigns the incoming job to that node (309).

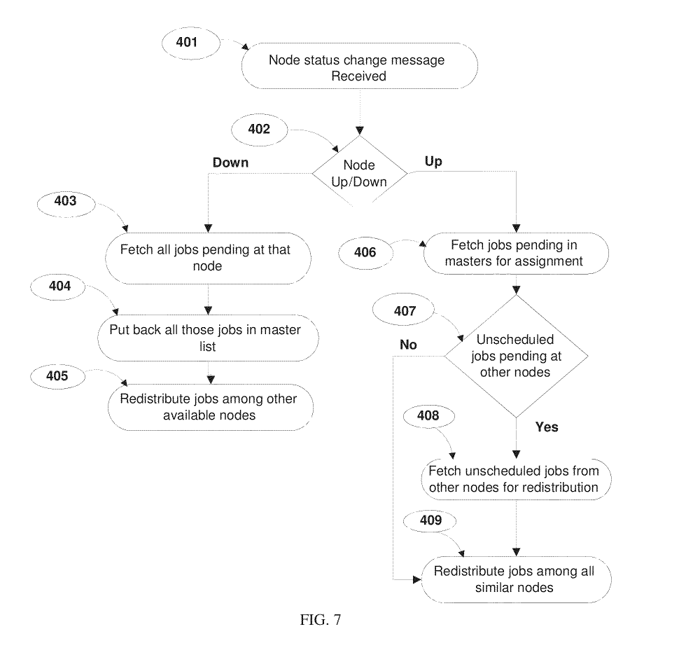

Turning to FIG. 7, the drawing illustrates an exemplary flow chart for the sequence of events in case of node failure/recovery. In this embodiment, whenever a status change message is received (401) from the node, the load balancer checks whether the node has failed or recovered from a failure (402) based on status in the message payload. If the status of the job is updated as failed all the jobs assigned to that node (403) is rolled back to the staging area (205). Further, the load balancer may be configured to redistribute these jobs among other available compute nodes (405). In case of node recovery from a failure, all the jobs are fetched from the staging area and assigned back to the node (406). In addition, the node may now be considered a candidate, and further redistribution from other available nodes (407) may be done to attain an optimal level of resource utilization (408).

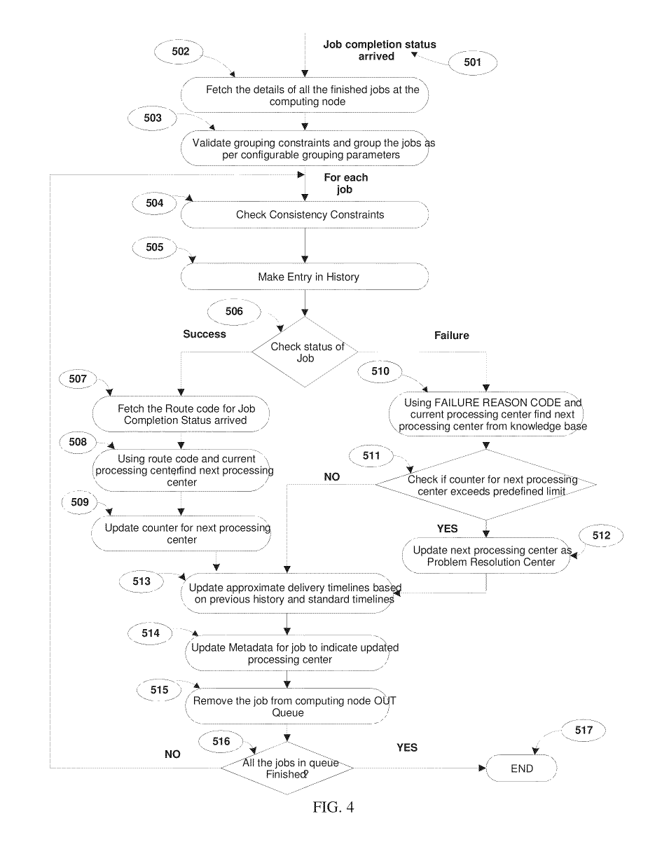

FIG. 4 illustrates an exemplary flow chart of a typical Job Dispatcher under another embodiment. On receipt of the Job completion status message (either success or failure) (501) the Job Dispatcher is invoked. In this embodiment, the dispatcher first fetches the details of all finished jobs corresponding to the available computing node (502), and validates the grouping constraints if any and groups the jobs as per configurable grouping parameters (503). For each job in the group, it preferably checks consistency constraints (504) and inserts a record into the history database (505). The dispatcher checks the status of the Job (506) and obtains the route tag for the job from the KB (507) in case the status flag is a success. The dispatcher implements a lookup service to obtain the next processing application (508) from KB using the route tag and current processing application. It then updates the counter of the next processing application (509). It accordingly moves the job to the staging area of the subsequent processing application (513). Moreover, if status flag shows a failure, then it finds next processing centre using reason tag and current processing application and moves it to the staging area of the corresponding processing application after consulting the KB (510). An exemplary representation of the KB for handling rejections is shown below in XML representation.

```
  <?xml version=“1.0” encoding=“utf-8”?>
<xs:schema attributeFormDefault=“unqualified” elementFormDefault=
  “qualified” xmlns:xs=“http://www.w3.org/2001/XMLSchema”>
  <xs:element name= “route”>
  <xs:complexType> <xs:sequence> <xs:element maxOccurs=
  “unbounded” name=“route”>
        <xs:complexType> <xs:attribute name=“sourceapp” type=
          “xs:string” se=“required” /> <xs:attribute name=
          “destapp” type=“xs:string”
          use=“required” /> <xs:attribute name=“reason” type=
          “xs:string”
          use=“required” />
  </xs:complexType> </xs:element> </xs:sequence> </xs:complexType>
  </xs:element>
</xs:schema>
```

If the source application rejects the request with a specific reason, the dispatcher routes the request to the appropriate destination application.

The dispatcher may then check if a counter for next processing center exceeds predefined limit (511). If yes, then it means it has exceeded its limit for that processing centre and thus is problematic case and to avoid infinite looping, it is to be sent to an issue tracker for manual analysis. Therefore, a message is generated for resolving the issue in processing the Job at the issue tracker application (512). It accordingly updates metadata for job to indicate updated processing centre (513). The job is then removed from the compute node out queue (514). It may also check whether all jobs in a queue are finished (515). In case of Job(s) that are pending for dispatch a loop continues till all the jobs in the group are dispatched as a single unit.

The estimated time (115) is computed based on the historical information on the timelines taken by the processing application to complete a similar type of Job. The database table also contains the standard deviations along with the average time taken for Job completion. When the ingest engine (101) makes an entry of the request into the database the estimated timelines are computed as

$$E ( p ) = {\sum }_{i = 1}^{n} mean ( {T ( p )}_{wi} ) , \qquad ( 9 )$$

and then transmitted back to the user. The variable T(P) represent the time taken for the product P at workcenter i denoted by wi

As per the preferred embodiment the delivery time line (117) of the product will be maintained in the transaction database (102) corresponding to the user request. The delivery time line (117) are recomputed whenever a product takes a hop from one processing application (44) to another depending upon the actual time taken by application to generate the product. Let TO denote the outgoing time of the product and TI be the time at which the product is assigned for processing. For each product p the delivery time may be computed as

$$E ( p ) = {\sum }_{i = 1}^{k} {TO ( p )}_{ai} - {TI ( p )}_{ai} , \qquad ( 10 )$$

where ai represents the i^{th} application involved in the workflow, n denotes the total number of processing application required to be invoked for completing the workflow and k≦n denotes the number of applications that have completed the process.

In view of the above detailed description, it can be appreciated that the invention provides a method and system for driving a workflow through a message driven communication with persistence in the dynamic production environment. The operations involved in the workflow are coordinated by sending and receiving an acknowledgment from the processing applications. The orchestration of workflows keeping in view the performance of different component is disclosed. A reliable distribution of messages and workload optimization leads to effective utilization of resources. The disclosed methods would help the business to obtain customer satisfaction by paving a way for dynamic customer relationship management.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A network-based method of controlling a production workflow in a node-based network utilizing message-driven, persistent, asynchronous communication, comprising the steps of:
receiving a task request pursuant to the workflow;
providing a tuple for the task request and invoking a stored procedure in response to the task request, wherein the stored procedure comprises generating and transmitting an application-specific message relating to the requested task, and wherein the tuple is associated with the application-specific message;
determining if an acknowledgement has been received to the application-specific message;
providing a message status based on the determination if an acknowledgement has been received;
obtaining a rule for the task request from a knowledge base and moving the tuple to a staging area based on the rule;
determining a network condition, and moving the tuple to an application-specific queue if it is determined that a predetermined network condition exists;
updating the tuple in the application-specific queue based on at least one of a status message and priority message received.

2. The network-based method of claim 1, wherein:
the step of and invoking a stored procedure is performed by an ingest engine;
the step of determining if an acknowledgement has been received is performed by a dispatcher engine;
the step of determining a network condition and resource availability is performed by a load balancer; and
the step of moving the tuple to an application-specific queue is performed by a dispatcher engine on update of tuple by the processing application;

3. The network-based method of claim 1, further comprising the step of moving the application-specific message to an exception queue if an acknowledgement has not been received after a predetermined number of attempts defined in the KB.

4. The network-based method of claim 1, wherein the rule is configured in the knowledge base to map an input tag related to the task request to a route tag to the staging area.

5. The network-based method of claim 1, wherein the network condition comprises states of processing applications in the network, said method further comprising the steps of:
resolving ties during distribution among nodes in the network based on a current state of processing applications relating to the task request;
receiving parameters relating to network conditions;
obtaining a distribution rule for routing distribution based on the parameters; and
assigning one or more priorities to task requests based on the distribution rule.

6. The network-based method of claim 5, further comprising the steps of
receiving a node message relating to a status of a node; and
modifying the distribution rule such that the tuple is moved from the application-specific queue to a secondary queue based on the node message.

7. The network-based method of claim 5, wherein the step of resolving ties during distribution comprises the step of calculating estimates using the distribution pattern among nodes.

8. The network-based method of claim 1, further comprising the step of storing at least some of the steps of the production workflow for future processing.

9. A computer program product, comprising a tangible computer usable medium having a computer readable program code embodied therein, said computer readable program code adapted to be executed to implement a method for controlling a production workflow in a node-based network utilizing message-driven, persistent, asynchronous communication, said method comprising the steps of:
receiving a task request pursuant to the workflow;
providing a tuple for the task request and invoking a stored procedure in response to the task request, wherein the stored procedure comprises generating and transmitting an application-specific message relating to the requested task, and wherein the tuple is associated with the application-specific message;
determining if an acknowledgement has been received to the application-specific message;
providing a message status based on the determination if an acknowledgement has been received;
obtaining a rule for the task request from a knowledge base and moving the tuple to a staging area based on the rule;
determining a network condition, and moving the tuple to an application-specific queue if it is determined that a predetermined network condition exists;
updating the tuple in the application-specific queue based on at least one of a status message and priority message received.

10. The computer program product of claim 9, wherein:
the step of and invoking a stored procedure is performed by an ingest engine;
the step of determining if an acknowledgement has been received is performed by a dispatcher engine;
the step of determining a network condition is performed by a load balancer; and
the step of moving the tuple to an application-specific queue is performed by dispatch engine on update of tuples by the processing application.

11. The computer program product of claim 9, further comprising the step of moving the application-specific message to an exception queue if an acknowledgement has not been received after a predetermined number of attempts defined by the stored procedure.

12. The computer program product of claim 9, wherein the rule is configured in the knowledge base to map an input tag related to the task request to a route tag to the staging area.

13. The computer program product of claim 9, wherein the network condition comprises states of processing applications in the network, said method further comprising the steps of:
resolving times of distribution among nodes in the network based on a current state of processing applications relating to the task request;
receiving parameters relating to network conditions;
obtaining a distribution rule for routing distribution based on the parameters; and
assigning one or more priorities to task requests based on the distribution rule.

14. The computer program product of claim 13, further comprising the steps of
receiving a node message relating to a status of a node; and
modifying the distribution rule such that the tuple is moved from the application-specific queue to a secondary queue based on the node message.

15. The computer program product of claim 13, wherein the step of resolving times of distribution comprises the step of calculating estimates for distribution among nodes.

16. The computer program product of claim 9, further comprising the step of storing at least some of the steps of the production workflow for future processing.

17. A network-based method for processing workflows in a distributed environment for improving data distribution to a user, using an automatic prioritization engine comprising the steps of:
computing application-specific throughputs for each application associated with a respective type of job in the workflows;
storing the application-specific throughputs for each type of job in a knowledge base;
calculating at least one of a nominal and average delivery timeline for specific job types based on metadata relating to the workflow stored in the knowledge base;
computing the time spent taken for completion of job by at least one of (i) a particular application and (ii) by all applications involved in the workflow; and
incrementing a priority if the elapsed time is greater than the nominal time by fitting a piecewise linear function.
